(19) United States
(12) Patent Application Publication
(10) Pub. No.: US 2023/0166426 A1
(43) Pub. Date: Jun. 1, 2023

(54) HIGH-EFFICIENCY SAW CHAIN

(71) Applicant: Wuhu Jingfeng Garden Machinery Technology Co., Ltd., Anhui (CN)

(72) Inventors: Quanfu WANG, Anhui (CN); Guozhang MA, Anhui (CN); Liqun ZHANG, Anhui (CN)

(73) Assignee: Wuhu Jingfeng Garden Machinery Technology Co., Ltd., Anhui (CN)

(21) Appl. No.: 17/916,037

(22) PCT Filed: Aug. 24, 2021
(86) PCT No.: PCT/CN2021/114178

§ 371 Date: Sep. 30, 2022

(30) Foreign Application Priority Data
Nov. 5, 2020 (CN) 202011223618.6

(51) Int. Cl. B27B 33/14

(52) U.S. Cl. CPC B27B 33/14

(57) ABSTRACT

A high-efficiency saw chain, including a plurality of transmission pieces, a plurality of rebound transmission pieces, a plurality of cutters, a plurality of connecting pieces and a plurality of pin shafts. The product of the average pitch between two adjacent pin shafts in the saw chain, the maximum height of the saw chain and the maximum thickness of the saw chain is 406 to 450 mm3. The high-efficiency saw chain may reduce the volume of the saw chain, reduce the size of the saw chain, effectively reduce the energy consumption of the saw chain, and effectively prolong the battery life of a lithium battery or gasoline engine.

### BACKGROUND

### Technology Field

The application relates to the technical field of saw chains, and particularly, to a high-efficiency saw chain.

### Description of Related Art

Chain saws are portable saws powered by a lithium battery or a gasoline engine and mainly used for logging and wood building. The working principle of a chain saw is to perform shearing by the lateral movement of the staggered L-shaped blades of the saw chain. The blades are arranged on the saw chain in a left and right staggered manner, and the distance between the outer cutting surfaces of the left and right staggered blades is the maximum gap for cutting. When cutting, the upper cutting surfaces of the left and right staggered blades need to cut off the wood where the gap is located, and the upper cutting surfaces of the left and right staggered blades will overlap within the width of the gap. Due to the outdoor use requirement, chain saws evolve with needs to carry lithium batteries or gasoline engines as power, so taking the optimization of energy usage into account is a must.

### SUMMARY

In terms of the technical problems present in the prior art, the application proposes a high-efficiency saw chain.

A high-efficiency saw chain proposed in this application includes a plurality of transmission pieces, a plurality of rebound transmission pieces, a plurality of cutters, a plurality of connecting pieces, and a plurality of pin shafts. A product of an average pitch between two adjacent pin shafts in the saw chain, a maximum height of the saw chain, and a maximum thickness of the saw chain is 406-450 mm³.

Preferably, the plurality of transmission pieces are disposed at intervals, the rebound transmission piece is disposed between the transmission pieces, one rebound transmission piece is disposed between any two adjacent transmission pieces, and the plurality of transmission pieces and the plurality of rebound transmission pieces are in the same plane. Transmission protrusions are disposed on both the transmission piece and the rebound transmission piece, and a rebound protrusion is disposed on a side of the rebound transmission piece away from a transmission protrusion. The connecting piece is disposed at a connection between the transmission piece and an adjacent rebound transmission piece, the connecting piece is located on a side of a plane where the transmission piece and the rebound transmission piece are located, and the connecting piece is hinged with the transmission piece and the rebound transmission piece through the pin shaft. The plurality of cutters are disposed at intervals, any two adjacent cutters are located on two sides of the plane where the transmission piece and the rebound transmission piece are located, respectively. The any two adjacent cutters are in a symmetrical structure, the cutter corresponds to the connecting piece and is hinged with the pin shaft of the connecting piece, and two adjacent connecting pieces are connected to the cutter in a non-synchronous manner.

Preferably, the average pitch between two adjacent pin shafts in the saw chain is 7.62 mm, the maximum height of the saw chain is 12.40 mm, and the maximum thickness of the saw chain is 4.46 mm.

Preferably, the cutter includes a connecting base, a cutting portion connected to the connecting base, a depth limiting portion, and two shaft holes are disposed on the connecting base.

Preferably, a maximum height of the cutter is 7.62 mm, a maximum thickness of the cutter is 2.96 mm, a maximum width of the cutter is 13.17 mm, a distance between the two shaft holes on the connecting base is 8.14 mm, and a diameter of the shaft hole is 1.84 mm.

Preferably, an angle formed between an outer side surface of the depth limiting portion of the cutter and the connecting base is β,β=170°.

Preferably, a maximum height of the transmission piece is 9.55 mm, a groove with a depth of 0.03 mm is disposed on the transmission piece, a thickness of the transmission piece is 1.10 mm, a maximum width of the transmission piece (1) is 13.30 mm; a distance between two shaft holes on the transmission piece (1) is 7.10 mm, and a diameter of the shaft hole is 2.95 mm.

Preferably, a maximum height of the rebound transmission piece is 11.63 mm, a groove with a depth of 0.03 mm is disposed on the rebound transmission piece, a thickness of the rebound transmission piece is 1.10 mm, a maximum width of the rebound transmission piece is 13.30 mm, a distance between two shaft holes on the rebound transmission piece is 7.10 mm, and a diameter of the shaft hole is 2.95 mm.

Preferably, a maximum height of the connecting piece is 4.17 mm, a thickness of the connecting piece is 0.90 mm, a maximum width of the connecting piece is 13.03 mm, a distance between two shaft holes on the connecting piece is 8.14 mm, a diameter of the shaft hole is 1.84 mm, a distance from a center of the shaft hole of the connecting piece to a bottom end of the connecting piece is 2.06 mm.

Preferably, a concave arc surface is formed on the bottom end of the connecting piece, and a diameter of the arc surface is 10.13 mm.

A high-efficiency saw chain is proposed in the application. The product of the average pitch between two adjacent pin shafts in the saw chain, the maximum height of the saw chain, and the maximum thickness of the saw chain is 406-450 mm³. The volume of the saw chain is reduced, the saw chain is downsized, the energy consumption is reduced, and the battery life of the lithium battery or gasoline engine is effectively prolonged.

### BRIEF DESCRIPTION OF THE DRAWING

FIG. 1 is a schematic view of a structure a high-efficiency saw chain proposed by the application.

FIG. 2 is a side view of a high-efficiency saw chain proposed by the application.

FIG. 3 is a top view of a high-efficiency saw chain proposed by the application.

FIG. 4 is a schematic view of a structure of a transmission piece in a high-efficiency saw chain proposed by the application.

FIG. 5 is a schematic view of a structure of a rebound transmission piece in a high-efficiency saw chain proposed by the application.

FIG. 6 is a schematic view of a structure of a connecting piece in a high-efficiency saw chain proposed by the application.

FIG. 7 is a schematic view of a structure of a cutter in a high-efficiency saw chain proposed by the application.

FIG. 8 is a side view of a cutter in a high-efficiency saw chain proposed by the application.

FIG. 9 is a top view of a cutter in a high-efficiency saw chain proposed by the application.

### DESCRIPTION OF THE EMBODIMENTS

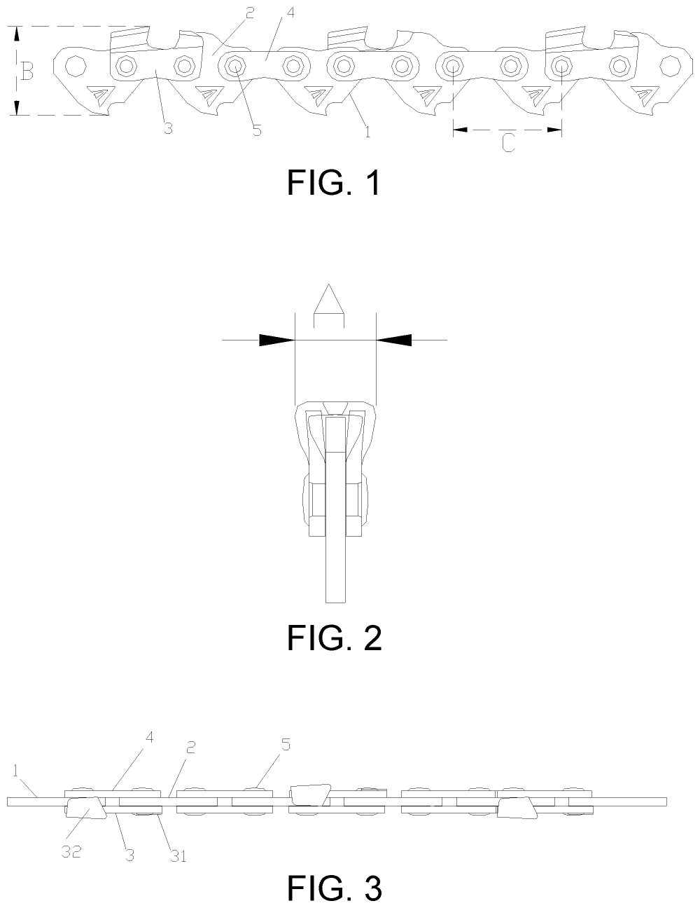

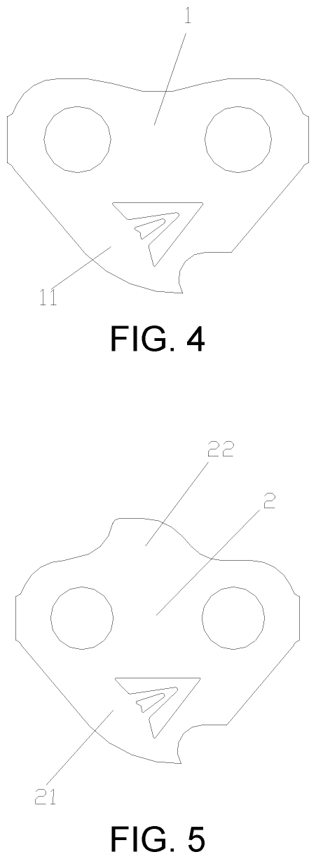

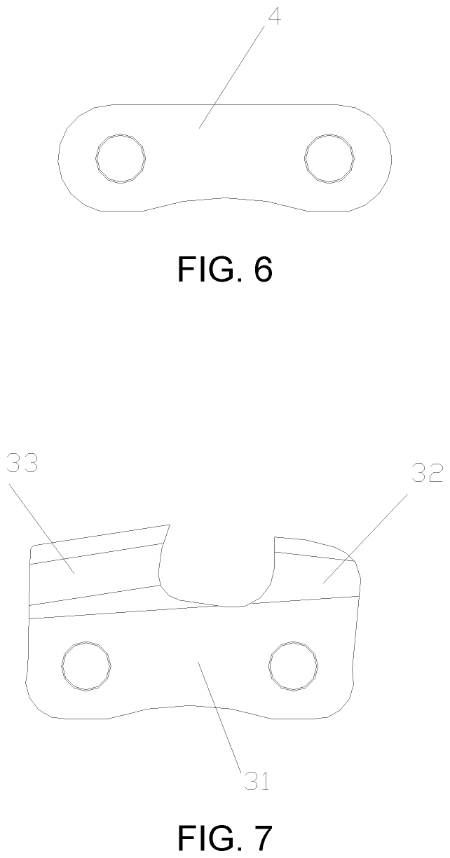

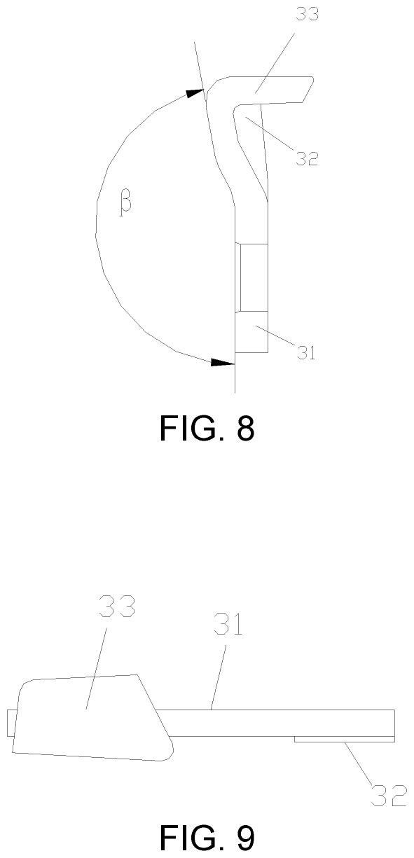

Referring to FIG. 1 to FIG. 9, the application proposes a high-efficiency saw chain, including a plurality of transmission pieces 1, a plurality of rebound transmission pieces 2, a plurality of cutters 3, a plurality of connecting pieces 4 and a plurality of pin shafts 5.

The plurality of transmission pieces 1 are disposed at intervals, the rebound transmission pieces 2 are disposed between the transmission pieces 1, and one rebound transmission piece 2 is disposed between any two adjacent transmission pieces 1. The transmission pieces 1 and the rebound transmission pieces 2 are in the same plane. A first transmission protrusion 11 and a second transmission protrusion 21 are disposed on the transmission piece 1 and the rebound transmission piece 2, respectively. A rebound protrusion 22 is disposed on a side of the rebound transmission piece 2 away from a transmission protrusion 6. The connecting piece 4 is disposed at the connection between the transmission piece 1 and the adjacent rebound transmission piece 2, and the connecting piece 4 is located on one side or two sides of the plane where the transmission piece 1 and the rebound transmission piece 2 are located. The connecting piece 4, the transmission piece 1, and the rebound transmission piece 2 are hinged through the pin shaft 5.

The plurality of cutters 3 are disposed at intervals, and any two adjacent cutters 3 are located on two sides of the plane where the transmission piece 1 and the rebound transmission piece 2 are located, respectively. The any adjacent two cutters 3 are in a symmetrical structure. The cutter 3 corresponds to the connecting piece 4 and is hinged with the pin shaft 5 of the connecting piece 4, and two adjacent connecting pieces 4 are connected to the cutter 3 in a non-synchronous manner.

The product of the average pitch between two adjacent pin shafts 5 in the saw chain, the maximum height of the saw chain, and the maximum thickness of the saw chain is 406-450 mm³.

In the saw chain of the application, the product of the average pitch between two adjacent pin shafts 5, the maximum height of the saw chain, and the maximum thickness of the saw chain is 406-450 mm³, which reduces the volume of the saw chain and downsizes the saw chain. The energy consumption of the saw chain is effectively reduced, and the battery life of the lithium battery or the gasoline engine is effectively prolonged.

### Embodiment 1

Referring to FIG. 1 to FIG. 9, the application proposes a high-efficiency saw chain, including a plurality of transmission pieces 1, a plurality of rebound transmission pieces 2, a plurality of cutters 3, a plurality of connecting pieces 4, and a plurality of pin shafts 5.

The plurality of transmission pieces 1 are disposed at intervals, the rebound transmission pieces 2 are disposed between the transmission pieces 1, and one rebound transmission piece 2 is disposed between any two adjacent transmission pieces 1. The transmission pieces 1 and the rebound transmission pieces 2 are in the same plane. A first transmission protrusion 11 and a second transmission protrusion 21 are disposed on the transmission piece 1 and the rebound transmission piece 2, respectively. A rebound protrusion 22 is disposed on a side of the rebound transmission piece 2 away from a transmission protrusion 6. The connecting piece 4 is disposed at the connection between the transmission piece 1 and the adjacent rebound transmission piece 2, and the connecting piece 4 is located on one side or two sides of the plane where the transmission piece 1 and the rebound transmission piece 2 are located. The connecting piece 4, the transmission piece 1, and the rebound transmission piece 2 are hinged through the pin shaft 5.

The plurality of cutters 3 are disposed at intervals, and any two adjacent cutters 3 are located on two sides of the plane where the transmission piece 1 and the rebound transmission piece 2 are located, respectively. The any adjacent two cutters 3 are in a symmetrical structure. The cutter 3 corresponds to the connecting piece 4 and is hinged with the pin shaft 5 of the connecting piece 4, and two adjacent connecting pieces 4 are connected to the cutter 3 in a non-synchronous manner.

In the embodiment, the cutter 3 includes a connecting base 31, a cutting portion 32 and a depth limiting portion 33 which are connected to the connecting base 31. Two shaft holes are disposed on the connecting base 31. The maximum height of the cutter 3 is 7.62 mm, the maximum thickness of the cutter 3 is 2.96 mm, the maximum width of the cutter 3 is 13.17 mm, the distance between the two shaft holes on the connecting base 31 is 8.14 mm, and the diameter of the shaft hole is 1.84 mm. The angle formed between the outer side surface of the depth limiting portion 33 of the cutter 3 and the connecting base 31 is β, β=170°.

In the embodiment, the maximum height of the transmission piece 1 is 9.55 mm, a groove with a depth of 0.03 mm is disposed on the transmission piece 1, the thickness of the transmission piece 1 is 1.10 mm, and the maximum width of the transmission piece 1 is 13.30 mm; the distance between the two shaft holes on the transmission piece 1 is 7.10 mm, and the diameter of the shaft hole is 2.95 mm.

In the embodiment, the maximum height of the rebound transmission piece 2 is 11.63 mm, a groove with a depth of 0.03 mm is disposed on the rebound transmission piece 2, the thickness of the rebound transmission piece 2 is 1.10 mm, and the maximum width of the rebound transmission piece 2 is 13.30 mm; the distance between the two shaft holes on the rebound transmission piece 2 is 7.10 mm, and the diameter of the shaft hole is 2.95 mm.

In the embodiment, the maximum height of the connecting piece 4 is 4.17 mm, the thickness of the connecting piece 4 is 0.90 mm, the maximum width of the connecting piece is 13.03 mm, the distance between the two shaft holes on the connecting piece 4 is 8.14 mm, the diameter of the shaft hole is 1.84 mm, the distance from the center of the shaft hole of the connecting piece 4 to the bottom end of the connecting piece 4 is 2.06 mm. A concave arc surface is formed on the bottom end of the connecting piece 4, and the diameter of the arc surface is 10.13 mm.

In the embodiment, the distance between the two shaft holes of the connecting piece 4 is equal to the distance between the two shaft holes of the cutter 3, so the average pitch C/2 between the two adjacent pin shafts 5 in the saw chain is 7.62 mm, the maximum height B of the saw chain is 12.40 mm, and the maximum thickness A of the saw chain is 4.46 mm. The product of the average pitch C/2 between two adjacent pin shafts 5 in the saw chain, the maximum height B of the saw chain, and the maximum thickness A of the saw chain is A*B*C/2=421.4 mm³.

The above descriptions are only preferred specific embodiments of the application, but the protection scope of the application is not limited thereto. Any modification, equivalent replacement, improvement, and the like made by any person skilled in the art who is familiar with the scope of the technical features disclosed in the application within the spirit and principle of the application shall be included in the protection scope of the application.

1. A high-efficiency saw chain, comprising a plurality of transmission pieces, a plurality of rebound transmission pieces, a plurality of cutters, a plurality of connecting pieces, and a plurality of pin shafts, wherein a product of an average pitch between two adjacent pin shafts in the saw chain, a maximum height of the saw chain, and a maximum thickness of the saw chain is 406-450 mm3.

2. The high-efficiency saw chain according to claim 1, wherein the plurality of the transmission pieces are disposed at intervals, the rebound transmission piece is disposed between the transmission pieces, one rebound transmission piece is disposed between any two adjacent transmission pieces, the plurality of the transmission pieces and the plurality of the rebound transmission pieces are in a same plane, a first transmission protrusion (11) and a second transmission protrusion are disposed on the transmission piece and the rebound transmission piece, respectively, and a rebound protrusion is disposed on a side of the rebound transmission piece away from a transmission protrusion; the connecting piece is disposed at a connection between the transmission piece and an adjacent rebound transmission piece, the connecting piece is located on a side of a plane where the transmission piece and the rebound transmission piece are located, and the connecting piece is hinged with the transmission piece and the rebound transmission piece through the pin shaft; the plurality of the cutters are disposed at intervals, any two adjacent cutters are located on two sides of the plane where the transmission piece and the rebound transmission piece are located, respectively, the any two adjacent cutters are in a symmetrical structure, the cutter corresponds to the connecting piece and is hinged with the pin shaft of the connecting piece, and two adjacent connecting pieces are connected to the cutter in a non-synchronous manner.

3. The high-efficiency saw chain according to claim 2, wherein the average pitch between two adjacent pin shafts in the saw chain is 7.62 mm, the maximum height of the saw chain is 12.40 mm, and the maximum thickness of the saw chain is 4.46 mm.

4. The high-efficiency saw chain according to claim 3, wherein the cutter comprises a connecting base, a cutting portion connected to the connecting base, a depth limiting portion (33), and two shaft holes are disposed on the connecting base.

5. The high-efficiency saw chain according to claim 4, wherein a maximum height of the cutter is 7.62 mm, a maximum thickness of the cutter is 2.96 mm, a maximum width of the cutter is 13.17 mm, a distance between the two shaft holes on the connecting base is 8.14 mm, and a diameter of the shaft hole is 1.84 mm.

6. The high-efficiency saw chain according to claim 5, wherein an angle formed between an outer side surface of the depth limiting portion (33) of the cutter and the connecting base is β, β=170°.

7. The high-efficiency saw chain according to claim 3, wherein a maximum height of the transmission piece is 9.55 mm, a groove with a depth of 0.03 mm is disposed on the transmission piece, a thickness of the transmission piece is 1.10 mm, a maximum width of the transmission piece is 13.30 mm; a distance between two shaft holes on the transmission piece is 7.10 mm, and a diameter of the shaft hole is 2.95 mm.

8. The high-efficiency saw chain according to claim 3, wherein a maximum height of the rebound transmission piece is 11.63 mm, a groove with a depth of 0.03 mm is disposed on the rebound transmission piece, a thickness of the rebound transmission piece is 1.10 mm, a maximum width of the rebound transmission piece is 13.30 mm, a distance between two shaft holes on the rebound transmission piece is 7.10 mm, and a diameter of the shaft hole is 2.95 mm.

9. The high-efficiency saw chain according to claim 3, wherein a maximum height of the connecting piece is 4.17 mm, a thickness of the connecting piece is 0.90 mm, a maximum width of the connecting piece is 13.03 mm, a distance between two shaft holes on the connecting piece is 8.14 mm, a diameter of the shaft hole is 1.84 mm, a distance from a center of the shaft hole of the connecting piece to a bottom end of the connecting piece is 2.06 mm.

10. The high-efficiency saw chain according to claim 9, wherein a concave arc surface is formed on the bottom end of the connecting piece, and a diameter of the arc surface is 10.13 mm.
